(19) United States
(12) Patent Application Publication
(10) Pub. No.: US 2004/0054608 A1
(43) Pub. Date: Mar. 18, 2004

(54) Method and system for managing the need of doctor blades

(76) Inventors: Sami Liiri, Jyvaskyla (FI); Heikki Toivanen, Jyvaskyla (FI); Pasi Viitasalo, Jyvaskyla (FI)

Correspondence Address: STIENNON & STIENNON, 612 W. MAIN ST., SUITE 201, P.O. BOX 1667, MADISON, WI, 53701-1667, US

(21) Appl. No.: 10/451,504

(22) PCT Filed: Dec. 18, 2001
(86) PCT No.: PCT/FI01/01118

(30) Foreign Application Priority Data
Dec. 22, 2000 (FI) 20002830

(51) Int. Cl. G06F 17/60

(52) U.S. Cl. 705/28

(57) ABSTRACT

Doctor blades are stored and used in a paper/board mill in which the quantity of the doctor blades used is monitored, and information is transmitted by data transfer means (20) to a data management system (23, 24) of the manufacturer/supplier of the doctor blades to manage the doctor blade situation. In the method, the information about the doctor blades is received by data collection means (22) connected to the data management system. The information is processed in the data management system (23, 24). When needed, a doctor blade/doctor blades is/are delivered to the paper/board mill to keep the quantity of doctor blades as desired. The system has data transfer means (20) for transmitting the quantity of the doctor blades to a data management system (23, 24) of a supplier/manufacturer. A means may be provided for giving the alarm to deliver, when needed, new doctor blades to the paper/board mill.

### CROSS REFERENCES TO RELATED APPLICATIONS

This application is a U.S. National Stage application of International Application No. PCT/FI01/01118, filed Dec. 18, 2001, and claims priority on Finnish Application No. 20002830, which was filed on Dec. 22, 2000, the disclosures of both of which applications being hereby incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a method for managing the need of doctor blades, in which method doctor blades are stored and used in a paper/board mill in which the quantity of the doctor blades used is monitored.

The invention also relates to a system for managing the need of doctor blades, comprising storage/handling devices for doctor blades in a paper/board mill and means for detecting the quantity of the doctor blades/doctor blade.

A doctor blade is an important part which secures the performance of a paper/board machine, which blade in connection with a roll maintains the condition of the roll surface and allows a web portion that is to be run into the pulper to be passed out of connection with the roll. There are different types of doctor blades and they are made of different materials, such as steel, glass fibre laminate, carbon fibre laminate and other composite materials. Doctor blades of different types and made of different materials are needed because doctor blades are used in connection with rolls of different basic unit assembly groups of the paper/board machine, from the wire section to the finishing section, because of which the requirements vary concerning an optimally performing doctor blade. For this reason, a paper/board mill must have in connection with the machine or in the vicinity thereof a store with doctor blades for different uses. The doctor blade is critical in a number of positions, i.e. when it wears and becomes useless or when it is damaged, the entire machine may even have to be stopped if a suitable replacement doctor blade is not available.

As known in the prior art, for example, an agent of the manufacturer/supplier of doctor blades makes an inventory of the doctor blade stores at regular intervals and, based on the inventory, delivers a sufficient quantity of replacement blades to the store. This naturally requires an abundance of work and staff because there are paper/board mills in different parts of the world and they have different types of doctor blade needs. Consequently, it has been necessary to keep large doctor blade stores, with the result that much capital has been tied up in them.

In many cases, management of the doctor blade situation has been arranged such that the doctor blade becomes the user's property only at the stage when it is removed from storage and until then the doctor blades are the property of the manufacturer/supplier. Thus, large stores tie up an abundance of doctor blade manufacturer's/deliverer's capital.

Metso Paper, Inc.'s FI utility model registration 3395 discloses an arrangement in connection with the handling of doctor blades. Here, the doctor blades are disposed in storage boxes and the boxes are disposed in a separate carriage comprising compartments for different types of doctor blades. The carriage with wheels can be easily moved to different positions in a paper or board machine and the carriage includes a cover which can be opened and closed and which is preferably made of a transparent material, so that the storage boxes placed in the carriage and the labels on the boxes can be seen through the cover. Providing the carriage with a cover that can be opened/closed prevents contamination and damage to the doctor blade storage boxes made of cardboard and to the doctor blades inside the boxes. The cover of the carriage can also be locked, thereby ensuring that only select persons have access to the doctor blades. In connection with the top cover of the carriage, there are preferably index labels indicating the compartments in the carriage in index compartments for doctor blades of different widths/different lengths/made of different materials.

Metso Paper, Inc.'s FI patent 103 595 describes an arrangement for storage of doctor blades, in which a storage box is used for doctor blades and, inside the storage box, the doctor blades have been joined together at their ends and the blades have been wound into a coil. The doctor blade coil is placed in the storage box, in which connection the doctor blades can be taken/pulled out of said storage box by unwinding the coil of doctor blades through an opening made to the side surface of the box.

Metso Paper, Inc.'s FI patent application 980514 discloses a storage carriage for doctor blades, comprising at least one doctor blade coil from which the doctor blade can be unwound. The doctor blade material on the coil can be unwound through a separate measurement device and through a cut-off device. The cut-off device comprises in its connection a measurement device from which the pulled-out length of the doctor blade and the residual length remaining in the coil can be read. At a desired point, the feed of the doctor blade from the coil is stopped, and the doctor blade is cut off to a desired length. The doctor blade coil is fitted around a shaft, which is mounted revolvingly, and the band of the doctor blades is passed through separate guides to the cut-off device, in which connection a measurement detector of the measurement device is located in the immediate vicinity of the cut-off device, which measurement detector measures the blade length that has been fed. The blade length that has been fed out can be read from a display placed in connection with a central unit and, in addition, the blade length that remains on the doctor blade coil can be read from the display. The doctor blade coil is located in a separate carriage, which can be moved to different positions in connection with a paper/board machine and the same carriage can be used in different positions while the carriage comprises a number of different doctor blade coils and separate cut-off means and measurement detectors for said doctor blade coils.

Metso Paper, Inc.'s FI patent 103 596 discloses an apparatus for replacement of a doctor blade, in which a doctor blade is passed from a doctor blade coil, preferably from a doctor blade storage box. The apparatus comprises, at one end of a roll, a blade feed device and, at the other end of the roll, a blade pull device. Both devices are operated when a blade is fed from a doctor blade coil into connection with the roll. The doctor blade is passed into a blade opening of a doctor blade holder for a conventional doctor blade, which holder is provided on a frame beam, and the doctor blade is locked in its position in the blade opening by means of loading devices which operate as a blade positioning device and, at the same time, as a locking means.

Metso Paper, Inc.'s above-mentioned patents/applications/utility model registrations describe arrangements of different types for handling/storage of doctor blades before they are put into use. In addition, paper or board mills use many types of stores in which different types of doctor blades are stored for different uses, in which stores, for example, in each compartment a doctor blade for a given use is stored.

### SUMMARY OF THE INVENTION

An object of the invention is to create a new method and system for managing the need of doctor blades.

An object of the invention is to provide an arrangement for establishing the inventory situation regarding the doctor blades in various paper/board mills without needing to go there.

An object of the invention is to advantageously provide an automatic system for making an inventory of the need of doctor blades in different sites of use in different paper/board mills.

One object of the invention is to create a method and a system for managing the need of doctor blades for use in connection with the doctor blade handling/storage arrangements disclosed in Metso Paper, Inc.'s patents/applications/utility model registrations described above.

With a view to achieving the above-noted objects as well as those that will come out later, the method according to the invention is mainly characterized in that, in the method, information about the quantity of doctor blades is transmitted by data transfer means to a data management system of the manufacturer/supplier of the doctor blades to manage the doctor blade situation, that in the method the information about the doctor blades is received by data collection means connected to the data management system, that the information is processed in the data management system, and that in the method, when needed, a doctor blade/doctor blades is/are delivered to the paper/board mill to keep the quantity of doctor blades as desired.

The arrangement according to the invention is in turn mainly characterized in that the system comprises data transfer means for transmitting the quantity of doctor blades to a data management system of the supplier/manufacturer of the doctor blades, which data management system comprises data collection means and means for processing data as well as means for giving the alarm to deliver, when needed, new doctor blades to the paper/board mill.

### BRIEF DESCRIPTION OF THE DRAWINGS

FIG. 1 is a schematic view of the system of this invention.

FIG. 2 is another schematic view of portions of the system of this invention.

### DESCRIPTION OF THE PREFERRED EMBODIMENTS

In accordance with the invention, in the paper/board mill, an inventory of the doctor blade situation is preferably made by an automatic procedure, for example, at fixed intervals, and a message is sent by a data transfer means to a data collection means of the doctor blade supplier/manufacturer, which data collection means transmits the message further to a data management system in which the doctor blade situation at each location is analyzed and, when needed, the data management system gives an alarm and the necessary doctor blade/doctor blades is/are sent to the location in question.

In connection with an advantageous application of the invention, a GSM modem arranged in connection with a logic system of a doctor blade store/handling device is used as the data transfer means, which GSM modem sends inventory data to the doctor blade supplier's/manufacturer's respective data collection means, preferably a GSM modem, and the inventories are gathered together by a computer and transferred to a database, which gives an alarm when the doctor blade supply at a given location is too low and, after that, the necessary doctor blade/doctor blades is/are delivered to the location in question.

In connection with the invention, instead of a GSM modem, as the data transfer means it is also possible to use other suitable similar means applicable to wireless data transfer, for example, a GPRS modem or equivalent. In connection with the invention, in addition to wireless global networks of the GSM or GPRS type, it is possible to use other similar networks and, in addition, when needed, as the data transfer means it is possible to use local networks, for example, a data transfer network based on the WLAN and Blue Tooth principles. When needed, data transfer may also take place partly as wire data transfer.

In accordance with one advantageous application, the invention is suitable for use in connection with a doctor blade carriage, in which blade boxes are placed side by side in desired positions. In said carriage, when a given blade material is required, a cut-off and measuring machine is moved to the material box in question, the desired length of the blade is given, and the device cuts the blade so that it is of correct length. The machinery of the carriage can also be run manually, in which case the display of the device shows the length of the blade drawn out. The machinery includes measuring sensors and position sensors. To allow the automatic inventory-taking in accordance with the invention, the blade materials in the carriages are preferably always located in the same regular positions, for example, glass fibre blades and carbon fibre blades are given positions of their own, and out of the locking handles in the machine all the other handles shall be open except that of the locking of the material to be cut. The inventory is made such that the logic system of the carriage stores in memory the cut blade lengths from different positions. A data transfer means connected to the logic system, preferably a GSM modem, sends at predetermined intervals inventory data to the manufacturer of doctor blades preferably as a text message. The doctor blade supplier has a data management apparatus, for example, a computer, which is provided with data collection means, preferably a GSM modem, and all inventories are gathered together by the computer and they are transferred to a doctor blade database, which gives an alarm if the doctor blade supply at any location is too low, after which said location is supplied with the necessary doctor blade/doctor blades. Thus, this requires that there shall be a data transfer means, preferably a GSM modem, connected to the logic system of the blade carriage and that the doctor blade manufacturer/supplier shall have a similar type of data collection means, preferably a GSM modem, and a data management apparatus, preferably a computer, and that there shall be a program which is connected to the logic system of the carriage and which is capable of storing the blade quantities taken out and of giving a transmission command at fixed intervals to the data transfer means, for example, a GSM modem. This system is very simple and reliable and easy to accomplish, and it makes it possible to manage the doctor blade needs of doctor blade carriages situated at several different locations.

In accordance with a second advantageous application of the invention, an automatic doctor blade store, which is placed in connection with a roll in a paper or board machine and which automatically feeds a new blade for the roll to replace a worn blade, is provided with logic control, in which connection management of the doctor blade situation in accordance with the invention may take place in a manner which corresponds to the arrangement described above in connection with blade carriages. A logic system is located in connection with a blade feed device, and the logic system stores in memory the quantity of the blade used and sends regularly inventory information through a data transfer means, preferably a GSM modem, to the doctor blade manufacturer/supplier, which information is processed in the above-noted manner in accordance with the invention.

In accordance with a third advantageous application of the invention, in connection with doctor blade boxes placed in doctor blade stores, inventory data management regarding the doctor blade situation can be most easily arranged such that a proximity switch is arranged in connection with each box, which switch opens and closes a circuit when an object comes sufficiently close, to a so-called operating distance. Such proximity switches include, among other things, inductive, capacitive, magnetic and optical proximity switches. Out of these, capacitive proximity switches are preferably used in connection with the invention, the capacitive proximity switches being composed of electronic components and not including movable parts, so that the service life is long and, in addition, these react with almost all materials and generate around themselves an electric field which becomes weaker when an object approaches the sensing head of the sensor, in which connection the sensor switches the circuit on or switches it off depending on the purpose. When in the doctor blade store a capacitive proximity switch is disposed in connection with each box location, for example, on the rear wall and logic control is arranged in connection with the store for control of the switch, a reliable system for detecting the presence of the box is achieved. In this method, it is required that the blade boxes of different materials have regular positions of their own on the shelves of the store. This arrangement operates as follows. When the doctor blade store is full, all proximity switches notify the logic system of the presence of boxes. When any box is removed from the store, the proximity switch of the box location in question notifies the logic system of the removed box, and the logic system gives an impulse to the data transfer means, for example, a GSM modem, and it sends information about the removed box to the doctor blade manufacturer/supplier, preferably in text message form. The data are collected, for example, by a computer, which is on all the time, through a similar type of data collection member, for example, a GSM modem, which collects information about every change and updates the inventory data in the doctor blade database. Preferably, an indicator light, for example, a red and a green light or another indicator system, can be disposed at each box position at the front in the doctor blade store to indicate the state of the proximity switch. For example, when a doctor blade agent fills the doctor blade store, he lifts a box to its position and pushes the box deeper on the shelf until the indicator light goes on indicating that the proximity switch has detected the box. Similarly, when a box is removed, the other indicator light goes on. By this arrangement, immediate information is advantageously received about any changes occurring in the doctor blade store, and data transfer need not be connected to the data system of paper or board mills. Moreover, proximity switches are low-cost and reliable in operation and simple. Instead of proximity switches, it is possible to use, for example, a microwave technique, an RF technique, or an inductive programmable identification device, which, however, are still to some extent difficult and expensive to implement by today's technology. To make an automatic inventory of the doctor blade situation, for example, by making use of the proximity switch technique, requires that in connection with the doctor blade store there are proximity switches or equivalent members, a logic system and a data transfer means, for example, a GSM modem, and preferably indicator lamps. If there are several doctor blade stores in the same paper/board machine room, control of all proximity switches or equivalent can be taken care of by the same logic system and by the same modem.

In accordance with a fourth advantageous application of the invention, an identification code, for example, a bar code, is associated with the doctor blade boxes to be placed/which have been placed in doctor blade stores, which code represents the type and the quantity of the particular doctor blade used as well as a code, for example, a suitable random number associated therewith to identify the particular doctor blade. By means of the identification code, for example, a bar code, the box is labelled individually. In addition, the positions in which the doctor blade boxes are placed in the doctor blade stores are identified precisely, for example, with a bar code, in which connection, when a new doctor blade box is placed in a doctor blade store, the bar code is read and it is combined with the bar code of the position in which it is placed in the doctor blade store, and the information is transmitted by a data transfer means to a data management system, whereby it is precisely known at which location of use of doctor blades any doctor blade is found, for example, the town where the mill is located, the name of the customer and the position of the doctor blade in each doctor blade store and, when a doctor blade is put into use, it is known what kind of doctor blade is removed from the doctor blade store position in question. The thus obtained information is transmitted through data transfer means to the doctor blade manufacturer/supplier, where information is collected into a data management system and, when needed, a new doctor blade is delivered to the location in question.

The system in accordance with the invention is suitable for use particularly well in situations in which doctor blades are passed from the ownership of the doctor blade manufacturer/supplier into the ownership of the customer when, for example, a doctor blade box is taken out of a doctor blade store or a doctor blade is put into use in another type of arrangement.

The automatic inventory-taking of doctor blades in accordance with the invention is easy to accomplish and it is reliable and independent of the data systems of paper mills because it uses automatic data transfer, preferably using GSM technology. When the entire doctor blade management uses automatic inventory taking, the doctor blade manufacturer/supplier gets a real-time database, in which action limits can be generated to optimum values according to the needs of each paper/board mill.

The paper/board mill has four different basic ways of detecting changes in the quantity of blades in the mill:

1. An automatic doctor blade store in which there are microswitches for different boxes, which operate in a situation when a blade box is removed from the store, and a logic device converts the microswitch information into transferable form and selects the destination to which the information is sent, and the information is sent by a data transfer means, for example, a GSM modem.

2. A manually operated doctor blade store in which, when the user takes a blade box from a blade store, he, for example, supplies information about it to a PC and the PC converts the information into transmitable form, and a data transfer means, for example, a GSM modem, sends the information.

3. In a system based on the use of a wireless telephone, for example, a GSM phone, when the user takes a blade box from a doctor blade store, he sends information about it by a text message.

4. The doctor blade manufacturer's/supplier's agent in the mill supplies information directly to, for example, his portable computer into a doctor blade database, which sends the information preferably through e-mail, for example, as a GSM message. At the doctor blade manufacturer's/supplier's, information is collected from data received from different sources, for example, by means of a server which is connected by a modem to a GSM network and has serial and parallel ports as well as a GSM control arrangement and the necessary databases as well as software for the person giving the alarm and impulse software which notifies the database to transfer information to the database, and software which updates the inventory data and compares them with action limits and, when an alarm is triggered, sends information about it to the person responsible for store maintenance by e-mail or to the GSM server.

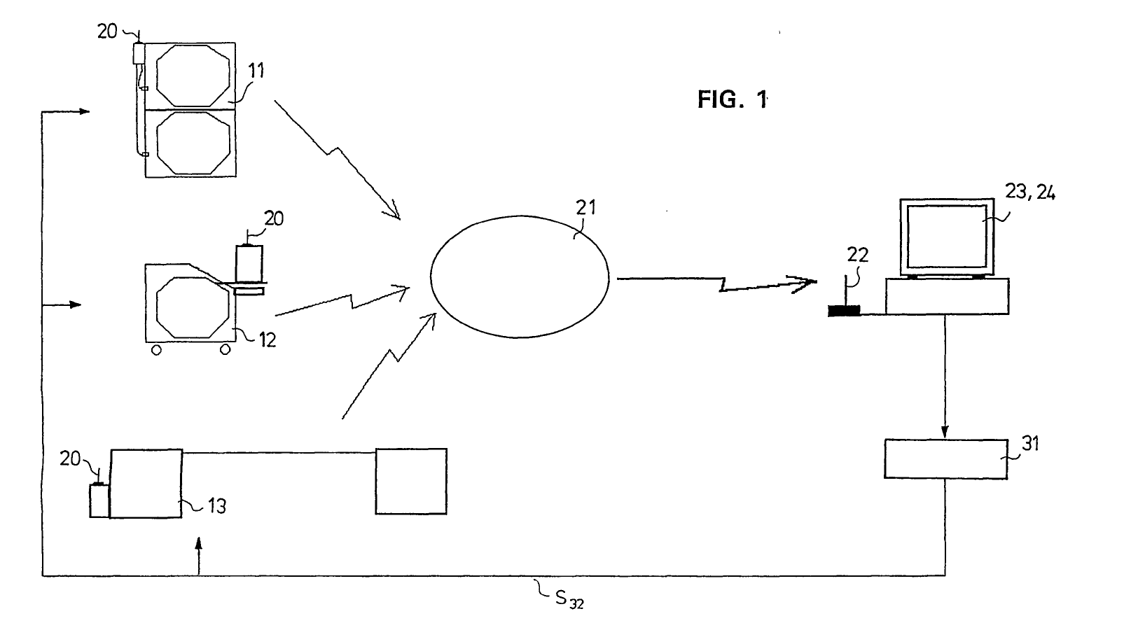

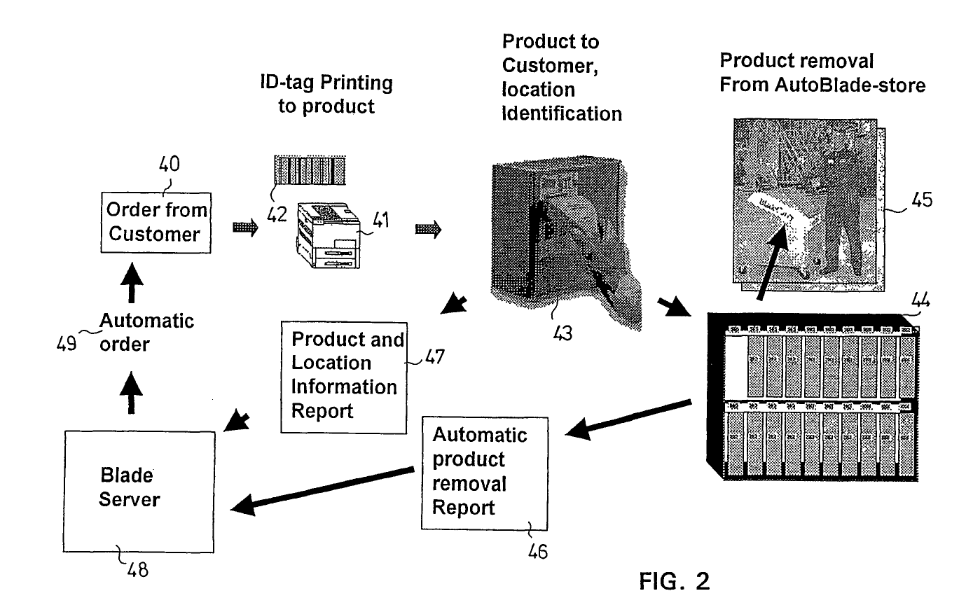

Management of doctor blades in accordance with the invention is schematically shown in FIGS. 1 and 2 with reference to some of its advantageous applications.

In accordance with the application shown in FIG. 1, information about the need of doctor blades in different types of doctor blade stores or handling devices 11, 12, 13 in a paper/board mill is transmitted by a data transfer means 20, preferably a GSM modem, through a GSM network 21 through a data collection means 22, preferably a GSM modem, of a doctor blade manufacturer/supplier to a data management system 24 in a computer 23, which data management system processes the data and, when it detects an action limit at any location, it transmits information about it further to a delivery unit 31, after which the necessary quantity of doctor blades is sent to said location, which is indicated by the arrow figure S32.

In the application shown in FIG. 2, the needed doctor blade is ordered by an order 40 placed by a paper/board mill. The manufacturer attaches an identification code 42, for example, a bar code to a doctor blade box 41 for individual identification of the doctor blade. The identification code contains information about the type and quantity of the doctor blade as well as a portion individually identifying the doctor blade, for example, a random number. When the doctor blade has been delivered to the paper/board mill, its identification code, for example, a bar code, is read, as shown in the figure at 43, after which the doctor blade is placed in a doctor blade store 44 in a precisely identified position. The information is supplied to a data management system 47. When the doctor blade is removed from the doctor blade store or from a transport carriage 45 for doctor blades, information is transmitted through data transfer means as a report 46 to a data management system 48, which processes the information and, when needed, prepares an automatic order for delivery of new doctor blades to the location in question, stage 49. In the system shown in FIG. 2, the information is preferably transmitted utilizing wireless data transfer means, for example, utilizing a GSM or a GPRS system. It is also possible to use local networks, for example, ones based on a WLAN or a Blue Tooth system and, when needed, part of the data transfer system may also be provided through a wire network.

Above, the invention has been described with reference to some of its advantageous embodiment examples only, but the invention is not by any means meant to be strictly confined to the details of them.

1. A method for managing the need of doctor blades, in which method doctor blades are stored and used in a paper/board mill in which the quantity of the doctor blades used is monitored, characterized in that, in the method, information about the quantity of doctor blades is transmitted by data transfer means (20) to a data management system (23, 24) of the manufacturer/supplier of the doctor blades to manage the doctor blade situation, that in the method the information about the doctor blades is received by data collection means (22) connected to the data management system, that the information is processed in the data management system (23, 24), and that in the method, when needed, a doctor blade/doctor blades is/are delivered to the paper/board mill to keep the quantity of doctor blades as desired.

2. A method according to claim 1, characterized in that, in the method, the information about the quantity of the doctor blades is transmitted from the paper/board mill by a telecommunication connection arranged in connection with a logic system of a store/handling device to the doctor blade supplier's/manufacturer's telecommunication connection (22) and the information about the quantities of the doctor blades is collected and processed by a computer.

3. A method according to claim 2, characterized in that, when the quantity of doctor blades at a certain location is too low, an alarm is given, on the basis of which the necessary doctor blades are delivered to the paper/board mill.

4. A method according to claim 2, characterized in that a GSM modem, a GPRS modem or equivalent is used as the telecommunication connection.

5. A method according to claim 1 to 4, characterized in that the information about the quantities of doctor blades is gathered together from all different locations and transferred to a doctor blade database, which processes the information and gives an alarm if the doctor blade situation at a certain location is below an action limit, and that in the method, when needed, the necessary doctor blade/blades is/are then delivered to said location.

6. A method according to any one of claims 1 to 5, characterized in that, in the method, in connection with a doctor blade carriage, blade boxes are placed in desired positions and, in each carriage, the quantity of blades is measured and the doctor blades are identified and the lengths of the doctor blades used are stored in a memory provided in connection with the carriage, and by means of a data transfer means connected to the memory the information about the quantity of doctor blades is sent at desired intervals to the doctor blade manufacturer/supplier.

7. A method according to claim 6, characterized in that the information about the quantity of doctor blades is sent by a GSM modem, a GPRS modem or equivalent connected to a logic system of the blade carriage through a GSM network, a GPRS network or equivalent to a GSM modem, GPRS modem or equivalent of the doctor blade manufacturer/supplier in order to process it by means of a computer program.

8. A method according to any one of claims 1 to 5, characterized in that, based on logic control disposed in connection with an automatic doctor blade store, information about the quantity of the doctor blades used is stored and the information is sent to the doctor blade manufacturer/supplier through a data transfer means at desired intervals.

9. A method according to any one of claims 1 to 5, characterized in that, by means of a proximity switch disposed in connection with doctor blade boxes placed in doctor blade stores, a doctor blade box placed in the vicinity thereof is detected, and the proximity switches placed in connection with the store are controlled by logic control, whereby the presence/absence of the box is detected, and information about a change in the doctor blade situation is transmitted by a data transfer means to the doctor blade manufacturer/supplier.

10. A method according to any one of claims 1 to 5, characterized in that the doctor blade to be placed in a given identified position in the doctor blade store is individually identified by means of an identification code disposed in connection with doctor blade boxes placed in doctor blade stores.

11. A system for managing the need of doctor blades, comprising storage/handling devices for doctor blades in a paper/board mill and means for detecting the quantity of the doctor blades/doctor blade, characterized in that the system comprises data transfer means (20) for transmitting the quantity of the doctor blades to a data management system (23, 24) of the supplier/manufacturer of the doctor blades, which data management system comprises data collection means (22) and means (24) for processing data as well as means for giving the alarm to deliver, when needed, new doctor blades to the paper/board mill.

12. A system according to claim 11, characterized in that a doctor blade store/a doctor blade handling device in the paper/board mill comprises a GSM modem, a GPRS modem or equivalent arranged in connection with a logic system of the doctor blade store/handling device for sending inventory data to the data collection means (22) of the doctor blade supplier/manufacturer, and a computer (23) for gathering the inventory data together and for processing them in a database (24), and means for providing an alarm when the quantity of doctor blades at a certain location is too low and for delivery to the paper/board machine.

13. A system according to claim 11 or 12, characterized in that the system comprises data management devices for gathering the quantities of doctor blades together from all different inventory locations and for transferring them to a doctor blade database, which processes the data and gives an alarm if the doctor blade situation at a certain location is below an action limit.

14. A system according to any one of claims 11 to 13, characterized in that the system is disposed in connection with a doctor blade carriage, in which doctor blade carriage blade boxes are placed in desired positions and each carriage has measuring devices for taking a desired blade quantity and position sensors for identifying the doctor blade and means for storing the lengths of the doctor blades used in memory and a data transfer means connected to the memory for sending inventory data at predetermined intervals to the doctor blade manufacturer.

15. A system according to claim 14, characterized in that a GSM modem, a GPRS modem or equivalent is connected to a logic system of the blade carriage, which GSM modem, GPRS modem or equivalent sends inventory data on the doctor blades through a GSM network, a GPRS network or equivalent to a GSM modem, a GPRS modem or equivalent of the doctor blade manufacturer/supplier in order to process it by means of a computer program.

16. A system according to any one of claims 11 to 13, characterized in that the system is disposed in connection with an automatic doctor blade store which has logic control for storing the quantity of the doctor blades used and a data transfer means for sending inventory data to the doctor blade manufacturer.

17. A system according to any one of claims 11 to 13, characterized in that the system is disposed in connection with a doctor blade store, in which doctor blade store in connection with doctor blade boxes there is a proximity switch which detects any doctor blade box placed in the vicinity thereof, and that logic control for controlling the switch is disposed in connection with the doctor blade store, so that in connection with the store there is a system for detecting the presence/absence of the doctor blade box, and that the store has a data transfer means for transmitting information about the situation of the doctor blade box to the doctor blade manufacturer/supplier.

18. A system according to claim 17, characterized in that the doctor blade store comprises detecting devices for detecting the operation of the proximity switch.

19. A system according to any one of claims 11 to 13, characterized in that the system is disposed in connection with a doctor blade store, in which doctor blade store in connection with doctor blade boxes there is an identification code by means of which each doctor blade is individually identified, and that in connection with the doctor blade store there is an identification code in connection with each position where a doctor blade is placed to individually identify the position, and that in connection with the doctor blade store, data management means are arranged, by which data management means the information about the doctor blades in the doctor blade store can be detected when a doctor blade is placed in the doctor blade store and when a doctor blade is removed from the doctor blade store, as well as means for transferring information to a data management system.
